(19) United States
(12) Patent Application Publication
(10) Pub. No.: US 2015/0379770 A1
(43) Pub. Date: Dec. 31, 2015

(54) DIGITAL ACTION IN RESPONSE TO OBJECT INTERACTION

(71) Applicants: David C. Haley, Jr., Seattle, WA (US); Christian Canton, Bellevue, WA (US); Jason Armenise, Redmond, WA (US); Jorge Tosar, Snoqualmie, WA (US); Nicholas Gervase Fajt, Seattle, WA (US); Russ Almond, Woodinville, WA (US); LaSean T. Smith, Renton, WA (US)

(72) Inventors: David C. Haley, Jr., Seattle, WA (US); Christian Canton, Bellevue, WA (US); Jason Armenise, Redmond, WA (US); Jorge Tosar, Snoqualmie, WA (US); Nicholas Gervase Fajt, Seattle, WA (US); Russ Almond, Woodinville, WA (US); LaSean T. Smith, Renton, WA (US)

(21) Appl. No.: 14/318,057

(22) Filed: Jun. 27, 2014

(51) Int. Cl. G06T 19/00; G02B 27/01; G09G 5/00

(52) U.S. Cl. CPC G06T 19/006; G09G 5/006; G02B 27/0172; G02B 2027/0178

(57) ABSTRACT

A system and method are disclosed for identifying objects, and performing a digital action with respect to the object in a mixed reality environment. Objects may be recognized by a processing unit receiving feedback from a head mounted display worn by a user in a number of ways. Once an object is identified, the digital action performed may be displaying additional information on the object, either on a virtual display slate or as a three-dimensional virtual representation.

### BACKGROUND

Mixed reality is a technology that allows virtual imagery to be mixed with a real world physical environment. A see-through head mounted mixed reality display device may be worn by a user to view the mixed imagery of real objects and virtual objects displayed in the user's field of view. A processor associated with the head mounted display device is able to create a three-dimensional map of the surroundings within which virtual and real objects may be seen.

There are many scenarios where a user sees an object in the real world and then wants to perform an action related to that object in the digital world, such as getting more information on the object from a website or database. For example, a shopper sees an item on a store shelf and wants to know more information on that item, or to see a preview of the item unboxed. At present, to accomplish this, the shopper performs some manual actions, such as looking up the object on his or her hand-held or desktop computing device, or carrying the object to a scanning station.

### SUMMARY

Embodiments of the present technology relate to a system and method for identifying objects, and performing a digital action with respect to the object in a mixed reality environment. Objects may be recognized in a number of ways by a processing unit receiving feedback from a head mounted display worn by a user. For example, objects may be recognized by explicit recognition techniques, such as for example capturing a bar or QR code, or by recognizing text or alphanumeric code. Objects may be recognized by implicit recognition techniques such as for example by object and surface identification. Objects may also be recognized by contextual recognition techniques, such as recognizing a location or situation in which the user is viewing the object and identifying an object from within that context. Objects may further be recognized by a user providing input as to the identity of the object. Combinations of these techniques may also be used to identify objects.

Once an object is identified, some digital action may be performed with respect to the object. The digital action may be displaying additional information on the object, either on a virtual display slate or as a three-dimensional virtual representation. Other digital actions may be taken such as for example purchasing the object, storing information relating to the object, or sending information regarding the object to a friend.

In an example, the present technology relates to a system for presenting a virtual environment, the virtual environment being coextensive with a real world space, the system comprising: a display device including a display unit for displaying one or more virtual objects in the virtual environment; and a processing unit operatively coupled to the display device, the processing unit at least assisting in identifying a selected object and the processing unit performing a digital action with respect to the selected object once identified.

In a further example, the present technology relates to a system for presenting a virtual environment, the virtual environment being coextensive with a real world space, the system comprising: a display device including a display unit for displaying one or more virtual objects in the virtual environment; and a processing unit operatively coupled to the display device, the processing unit at least assisting in identifying a selected real world object and the processing unit generating a virtual object displayed by the display device, the virtual object providing information with respect to the identified real world object.

In another example, the present technology relates to a method for presenting a virtual environment, the virtual environment being coextensive with a real world space, the method comprising: (a) receiving selection of a real world object in the real world space; (b) sensing at least one of markings and aspects of the real world object selected in said step (a); (c) identifying the real world object from at least one of the markings and aspects of the real world object sensed in said step (b); and (d) performing a digital action relating to the real world object upon said step (c) of identifying the real world object, said step of performing a digital action comprising the step of displaying a virtual object via a display device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIGS. 1A-1D are illustrations of a virtual environment implementing embodiments of the present technology.

FIG. 2 is a perspective view of one embodiment of a head mounted display unit.

FIG. 3 is a side view of a portion of one embodiment of a head mounted display unit.

FIG. 4 is a block diagram of one embodiment of the components of a head mounted display unit.

FIG. 5 is a block diagram of one embodiment of the components of a processing unit associated with a head mounted display unit.

FIG. 6 is a block diagram of one embodiment of the software components of a processing unit associated with the head mounted display unit.

FIG. 7 is a flowchart showing the operation of one or more processing units associated with a head mounted display units of the present system.

FIGS. 8-9 are more detailed flowcharts of examples of various steps shown in the flowchart of FIG. 7.

FIGS. 10-15 illustrate further examples of virtual environments implementing aspects of the present technology.

### DETAILED DESCRIPTION

Embodiments of the present technology will now be described with reference to the figures, which in general relate to a system and method for identifying an object and performing one or more digital actions with respect to the object in a mixed reality environment. In embodiments, the system and method may use a mobile mixed reality assembly to generate a three-dimensional scene map of the mixed reality environment. The mixed reality assembly includes a mobile processing unit coupled to a head mounted display device (or other suitable apparatus) having a camera and a display element.

The display element is to a degree transparent so that a user can look through the display element at real world objects within the user's field of view (FOV). The display element also provides the ability to project virtual images into the FOV of the user such that the virtual images may also appear alongside the real world objects. The system automatically tracks where the user is looking so that the system can determine where to insert a virtual image in the FOV of the user. Once the system knows where to project the virtual image, the image is projected using the display element.

In embodiments, the processing unit may build a model of the environment including the x, y, z Cartesian positions of real world objects including the user's hands, and virtual three-dimensional objects in the room or other environment. The positions of the head mounted display device may be calibrated to the model of the environment. This allows the system to determine the user's line of sight and FOV of the environment. Thus, a virtual image may be displayed to the user, adjusting the virtual image for any occlusions by other objects (real or virtual) in the environment. The three-dimensional model of the environment, referred to herein as a scene map, as well as all tracking of each user's FOV and objects in the environment may be generated by the mobile processing unit by itself, or working in tandem with other processing devices as explained hereinafter.

A virtual environment provided by the present system may be coextensive with a real world space. In other words, the virtual environment may be laid over and share the same area as a real world space. A user moving around a real world space may also move around in the coextensive virtual environment, and view virtual and/or real objects from different perspectives and vantage points. The virtual environment may fit within the confines of a room or other real world space. Alternatively, the virtual environment may be larger than the confines of the real world physical space.

As explained below, a user may select a real world object, and thereafter, the present system performs a digital action such as displaying information about the object. This information may be displayed to a user as text and/or graphics on a virtual display slate, explained below. A user may have more than one virtual display slate open, each with its own display of content. The displayed content may be any content which can be displayed on the virtual display slate, including for example static content such as text and pictures, or dynamic content such as video. Instead of a virtual display slate, three-dimensional virtual objects may be displayed to the user providing additional information or to assist in performing some digital action with respect to the object.

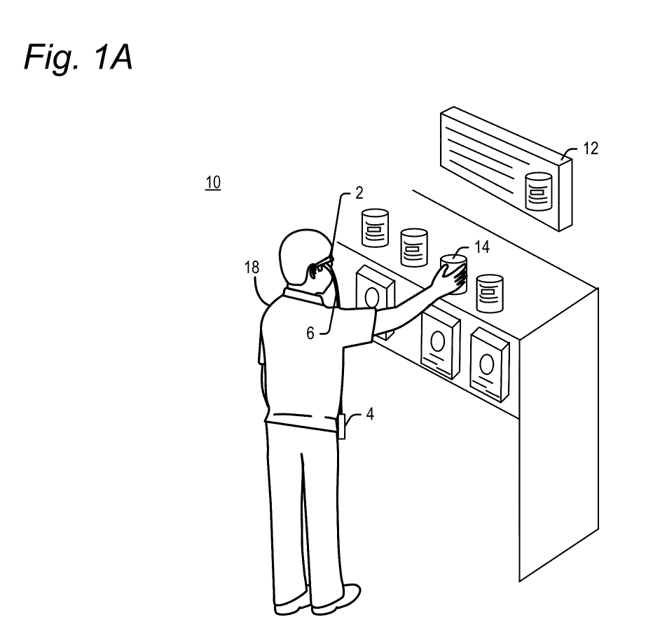

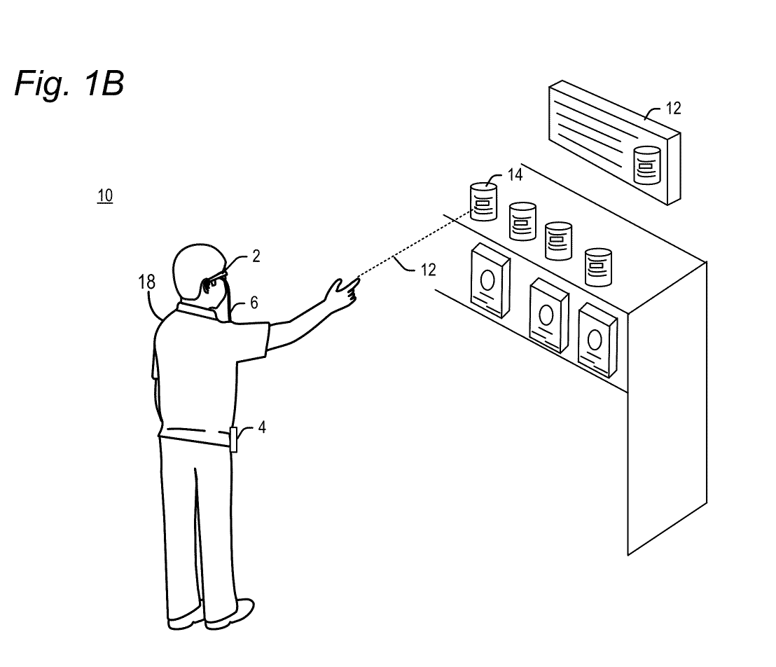

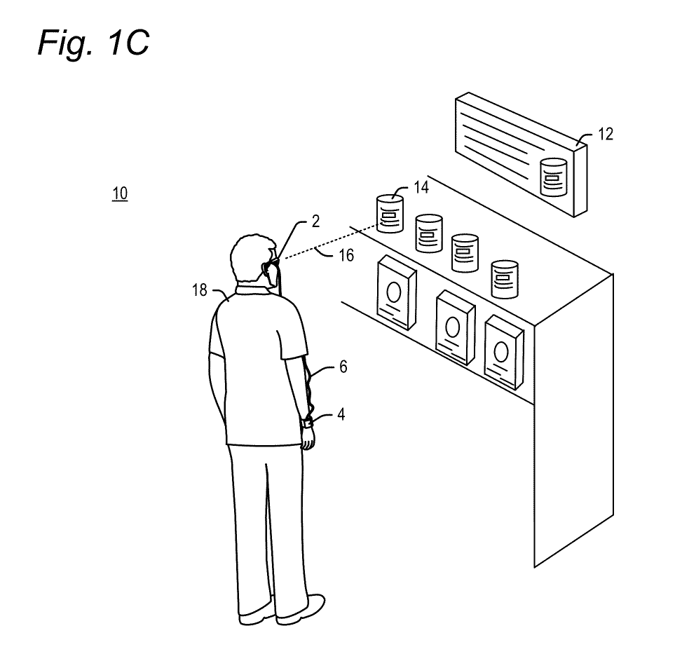

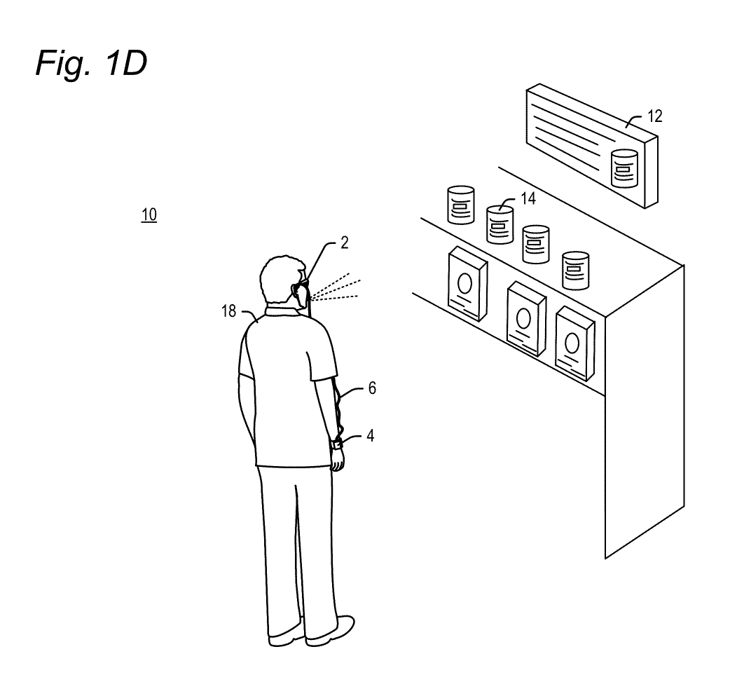

FIGS. 1A-1D illustrate a system 10 according to the present technology for providing a user 18 with a virtual experience by fusing virtual content 12 with real content 14 within a user's FOV. The virtual experience is provided to the user by a head mounted display device 2 working in tandem with a processing unit 4. The head mounted display device 2 is in communication with its own processing unit 4 via wire 6. In other embodiments, head mounted display device 2 communicates with processing unit 4 via wireless communication. The head mounted display device 2 and processing unit 4 are at times referred to herein collectively as the mobile mixed reality assembly. Head mounted display device 2, which in one embodiment is in the shape of glasses, is worn on the head of a user so that the user can see through a display and thereby have an actual direct view of the space and objects in front of the user. More details of the head mounted display device 2 are provided below.

In one embodiment, processing unit 4 is a small, portable device for example worn at a user's belt (FIGS. 1A and 1B), on the user's wrist (FIGS. 1C and 1D) or stored within a user's pocket. The processing unit 4 may for example be the size and form factor of a cellular telephone, though it may be other shapes and sizes in further examples. In further embodiments, the processing unit 4 may be incorporated into the head mounted display device 2 instead of being a separate unit. The processing unit 4 may include some or all of the computing power used to operate head mounted display device 2. In embodiments, the processing unit 4 communicates wirelessly (e.g., WiFi, Bluetooth, infra-red, or other wireless communication means) to remote websites and/or services including one or more servers or computing systems as explained below.

In accordance with aspects of the present technology shown in FIGS. 1A-1D, a user may choose to select or otherwise interact with one or more real world objects 14 appearing within the user's FOV. As used herein, the term “interact” encompasses both physical interaction and verbal interaction of a user with a real world object. Physical interaction may include a user touching the object, or performing a predefined gesture using his or her fingers, hands and/or other body part(s) recognized by the processing unit as a user-request for the system to perform a predefined action with respect to the real world object. Such predefined gestures may include, but are not limited to, pointing at, grabbing, and moving real world objects.

With regard to selecting and interacting with an object 14, as explained in detail below, the present system includes hardware and software that allows the mobile mixed reality assembly to construct a three-dimensional scene map of a user's surroundings, and to locate and track the positions of a user's hands and objects in that scene map in real time. Using this information, the present system is able to infer selection and interaction with an object by a user a number of ways, at least some of which are shown in FIGS. 1A-1D.

In the example of FIGS. 1A-1D, the present system identifies the contents of a can on a shelf, such as for example at a supermarket. However, it is understood that any of a wide variety of objects may be identified by the present system in a wide variety of environments. Some objects may be more easily identified than others as explained below.

FIG. 1A illustrates an example where a user selects an object by contacting the object. Contact by a user includes the user touching, grabbing, holding and/or moving a particular object. Using the scene map, the mobile mixed reality assembly is able to detect when a user's hand or hands come into contact with an object. The assembly can detect when the user's hand(s) occupy the same or adjacent three-dimensional space as the real world object. Alternatively or additionally, the assembly can detect movement of the object, when a user's hands are at or near the object, from which the assembly can infer that a user has moved the object or is holding the object.

A user contacting an object for some predetermined period of time may be interpreted by the present system as a desire by the user to identify the object and perform some digital action with respect to the object. As explained below, in further embodiments, paired actions (contact plus some other user action) may be used to indicate selection of an object to avoid instances where a user contacts an object for some purpose other than performing a digital action with respect to the object.

Referring now to FIG. 1B, instead of contacting an object, the present assembly may infer selection and interaction with an object 14 when a user is pointing at the object for some predetermined period of time. In particular, using a hand recognition and tracking algorithm explained below, the mobile mixed reality assembly is able to discern a user pointing a finger, and the direction in which the user is pointing. The present system may construct a ray continuing from the user's finger, and detect intersection of the ray with an object the user wishes to select.

As shown in FIG. 1B, in embodiments, the ray may be virtually displayed to the user by the mobile head mounted display device 2 (virtual ray 12) to assist the user in pointing at a specific desired object 14. In further embodiments, the ray may not be displayed to the user, but may simply be a mathematical construct used by the processing unit 4 to discern where the user is pointing.

At times, the present system may draw a clear inference that a user contacting an object or pointing at an object so as to select that object. However, in embodiments, the present system may also employ one or more software refinement algorithms to strengthen or negate the inference. One such refinement algorithm is to examine the position of the user's hand to determine a likelihood that the user is attempting to select or interact with a particular object 14. Even if not expressly contacting or pointing at an object 14, the user's hand may be close enough to a particular object, or performing movements in the direction of a particular object 14, so that the processor unit 4 can infer that the user wishes to select that object.

Another refinement algorithm may check how long the user is holding a position adjacent a particular object 14. For example, the user may simply be moving his hand to scratch his nose, or making some other movement unrelated to selecting an object 14. Accordingly, the processing unit may infer selection of a particular object if the user maintains the detected position for some predetermined period of time. The time may be two seconds in one example, but it may be longer or shorter than that in further embodiments. The refinement algorithms may be omitted in further embodiments.

Referring now to FIG. 1C, instead of or in addition to contact or pointing, the processing unit may infer selection of a specific object 14 from a user's head position. As discussed below, a face unit vector may be defined as extending straight out from a plane of the user's face. An example of face unit vector 16 is shown in FIG. 1C. In embodiments, if the face unit vector 16 intersects with an object for a predetermined period of time, the object may be selected. The present system may employ one or more software refinement algorithms to strengthen or negate the inference that the user is selecting a particular object within the annular region. Such refinement algorithms may examine how long a user is gazing at a particular object and/or how stable the face unit vector 16 is. Where the face unit vector is stable for a predetermined period of time, the system may infer the intent to select an object and not just moving his or her head past the object.

In further embodiments, the processing unit 4 may construct an annular region around the face unit vector, and look for objects 14 within that annular region. Where a single object 14 is within the predefined annular region for a predetermined period of time, the processing unit may infer selection of that object 14. On the other hand, where more than one object 14 is located within the predefined annular region, the present system may employ one or more refinement algorithms to disambiguate between those object.

One such refinement algorithm may determine which of the objects in the predefined annular region is closest to the user (i.e., the object which is the shortest distance away from the user along the face unit vector). The system may infer that the closest object is the object the user wishes to select.

Instead of or in addition to head position, sustained eye gaze at a real world object may be used to select an object. An eye tracking assembly (explained below) may be used to generate an eye unit vector. The eye unit vector extends perpendicularly from the surface of a user's eyes and indicates where the user is looking. The eye unit vector may be used to confirm or contradict a selection of an object by the face unit vector. In further embodiments, the eye unit vector may be used instead of the fact unit vector to determine selection of a particular object 14 by the user's gaze.

In a further embodiment illustrated in FIG. 1D, the mobile mixed reality assembly may determine selection of a particular object by speech commands issued by the user. As explained below, the mobile head mounted display device 2 may employ one or more microphones, and the processing unit 4 may employ a speech recognition algorithm. Using these components, the user may issue verbal commands which indicate selection of a specific object. For example, in FIG. 1D, the user 18 may say, “select object; top shelf, third from left.” The user may alternatively or additionally speak the name of a particular object. A wide variety of other verbal commands may be used to select a particular object.

In embodiments, two or more of the above-described selection methodologies may be used to select or confirm selection of a particular object. For example, a user may contact, point to or gaze at an object and speak its name. In further embodiments, the user may perform one of the actions described in FIGS. 1A-1D, coupled with some other predefined gesture (physical or verbal) to confirm that the user is in fact attempting to select a particular object. It is also understood that selection methodologies other than those described above with respect to FIGS. 1A-1D may be used to select a particular object.

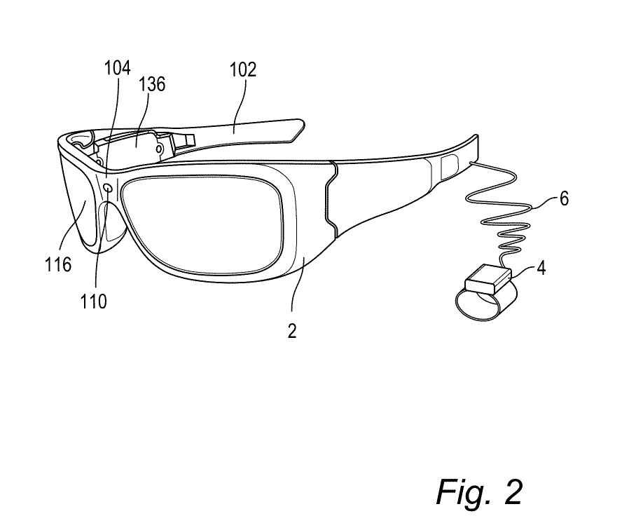

Once an object 14 has been selected, the present system identifies the object and then performs one or more digital actions with respect to the object. In the example of FIGS. 1A-1D, this digital action is to present a virtual display slate 12 on which is displayed additional information on the selected object. The details of the present system for identifying an object, and then performing one or more digital actions with respect to the identified object are explained below. The details of the mobile head mounted display device 2 and processing unit 4 which enable this identification and digital action will now be explained with reference to FIGS. 2-6.

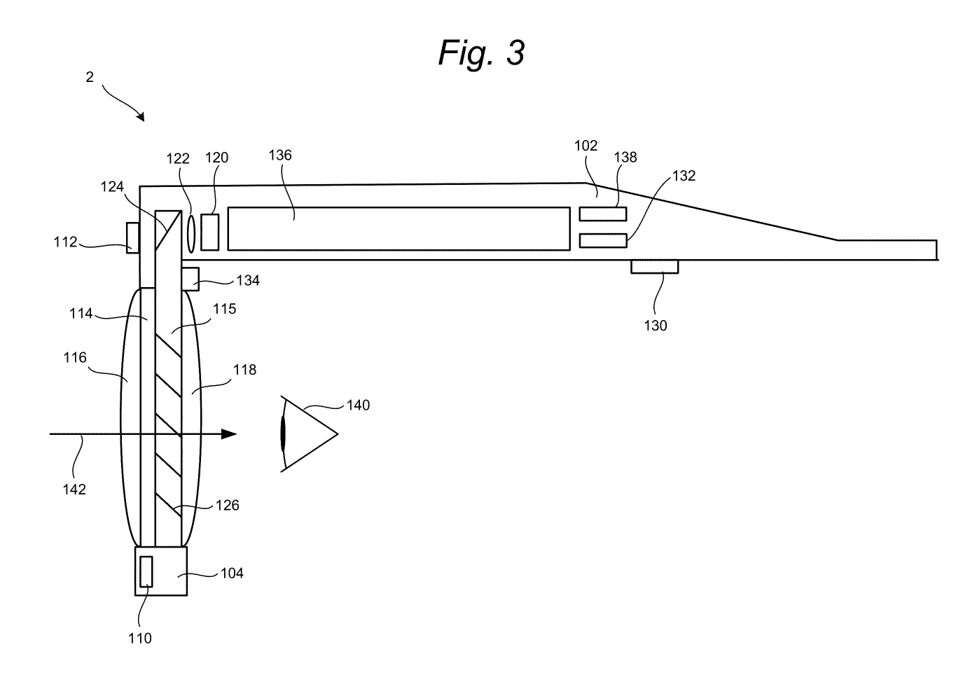

FIGS. 2 and 3 show perspective and side views of the head mounted display device 2. FIG. 3 shows only the right side of head mounted display device 2, including a portion of the device having temple 102 and nose bridge 104. Built into nose bridge 104 is a microphone 110 for recording sounds and transmitting that audio data to processing unit 4, as described below. At the front of head mounted display device 2 is room-facing video camera 112 that can capture video and still images. Those images are transmitted to processing unit 4, as described below.

A portion of the frame of head mounted display device 2 will surround a display (that includes one or more lenses). In order to show the components of head mounted display device 2, a portion of the frame surrounding the display is not depicted. The display includes a light-guide optical element 115, opacity filter 114, see-through lens 116 and see-through lens 118. In one embodiment, opacity filter 114 is behind and aligned with see-through lens 116, light-guide optical element 115 is behind and aligned with opacity filter 114, and see-through lens 118 is behind and aligned with light-guide optical element 115. See-through lenses 116 and 118 are standard lenses used in eye glasses and can be made to any prescription (including no prescription). In one embodiment, see-through lenses 116 and 118 can be replaced by a variable prescription lens. Opacity filter 114 filters out natural light (either on a per pixel basis or uniformly) to enhance the contrast of the virtual imagery. Light-guide optical element 115 channels artificial light to the eye. More details of opacity filter 114 and light-guide optical element 115 are provided below.

Mounted to or inside temple 102 is an image source, which (in one embodiment) includes microdisplay 120 for projecting a virtual image and lens 122 for directing images from microdisplay 120 into light-guide optical element 115. In one embodiment, lens 122 is a collimating lens.

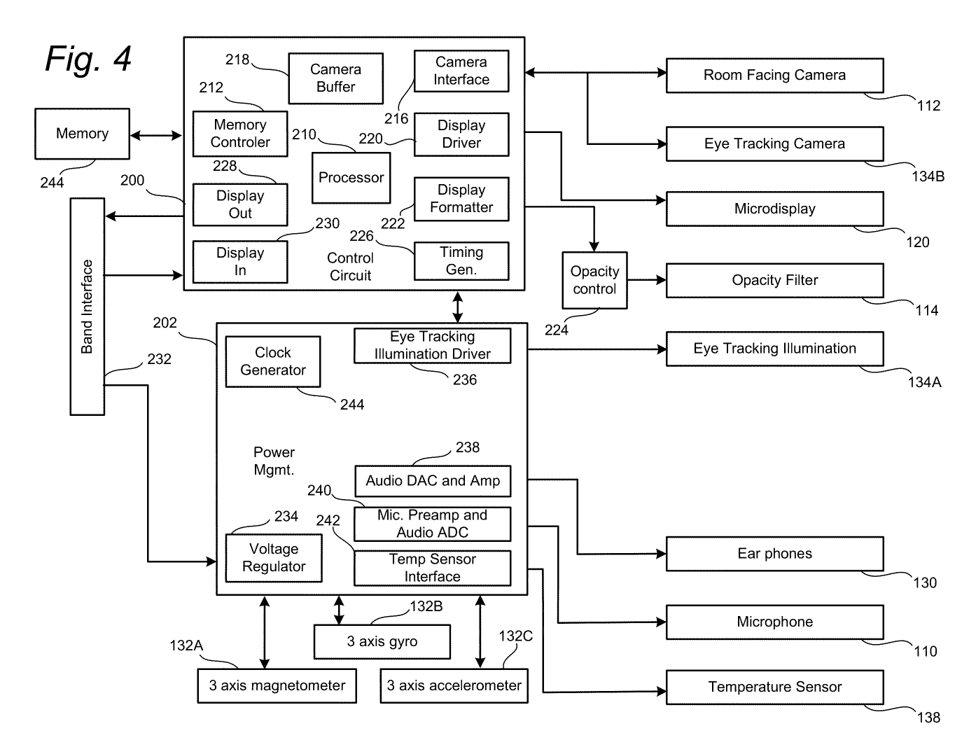

Control circuits 136 provide various electronics that support the other components of head mounted display device 2. More details of control circuits 136 are provided below with respect to FIG. 4. Inside or mounted to temple 102 are ear phones 130, inertial measurement unit 132 and temperature sensor 138. In one embodiment shown in FIG. 4, the inertial measurement unit 132 (or IMU 132) includes inertial sensors such as a three axis magnetometer 132A, three axis gyro 132B and three axis accelerometer 132C. The inertial measurement unit 132 senses position, orientation, and sudden accelerations (pitch, roll and yaw) of head mounted display device 2. The IMU 132 may include other inertial sensors in addition to or instead of magnetometer 132A, gyro 132B and accelerometer 132C.

Microdisplay 120 projects an image through lens 122. There are different image generation technologies that can be used to implement microdisplay 120. For example, microdisplay 120 can be implemented in using a transmissive projection technology where the light source is modulated by optically active material, backlit with white light. These technologies are usually implemented using LCD type displays with powerful backlights and high optical energy densities. Microdisplay 120 can also be implemented using a reflective technology for which external light is reflected and modulated by an optically active material. The illumination is forward lit by either a white source or RGB source, depending on the technology. Digital light processing (DLP), liquid crystal on silicon (LCOS) and Mirasol® display technology from Qualcomm, Inc. are examples of reflective technologies which are efficient as most energy is reflected away from the modulated structure and may be used in the present system. Additionally, microdisplay 120 can be implemented using an emissive technology where light is generated by the display. For example, a PicoP™ display engine from Microvision, Inc. emits a laser signal with a micro mirror steering either onto a tiny screen that acts as a transmissive element or beamed directly into the eye (e.g., laser).

Light-guide optical element 115 transmits light from microdisplay 120 to the eye 140 of the user wearing head mounted display device 2. Light-guide optical element 115 also allows light from in front of the head mounted display device 2 to be transmitted through light-guide optical element 115 to eye 140, as depicted by arrow 142, thereby allowing the user to have an actual direct view of the space in front of head mounted display device 2 in addition to receiving a virtual image from microdisplay 120. Thus, the walls of light-guide optical element 115 are see-through. Light-guide optical element 115 includes a first reflecting surface 124 (e.g., a mirror or other surface). Light from microdisplay 120 passes through lens 122 and becomes incident on reflecting surface 124. The reflecting surface 124 reflects the incident light from the microdisplay 120 such that light is trapped inside a planar substrate comprising light-guide optical element 115 by internal reflection. After several reflections off the surfaces of the substrate, the trapped light waves reach an array of selectively reflecting surfaces 126. Note that only one of the five surfaces is labeled 126 to prevent over-crowding of the drawing. Reflecting surfaces 126 couple the light waves incident upon those reflecting surfaces out of the substrate into the eye 140 of the user.

As different light rays will travel and bounce off the inside of the substrate at different angles, the different rays will hit the various reflecting surfaces 126 at different angles. Therefore, different light rays will be reflected out of the substrate by different ones of the reflecting surfaces. The selection of which light rays will be reflected out of the substrate by which surface 126 is engineered by selecting an appropriate angle of the surfaces 126. More details of a light-guide optical element can be found in United States Patent Publication No. 2008/0285140, entitled “Substrate-Guided Optical Devices,” published on Nov. 20, 2008. In one embodiment, each eye will have its own light-guide optical element 115. When the head mounted display device 2 has two light-guide optical elements, each eye can have its own microdisplay 120 that can display the same image in both eyes or different images in the two eyes. In another embodiment, there can be one light-guide optical element which reflects light into both eyes.

Opacity filter 114, which is aligned with light-guide optical element 115, selectively blocks natural light, either uniformly or on a per-pixel basis, from passing through light-guide optical element 115. Details of an example of opacity filter 114 are provided in U.S. Patent Publication No. 2012/0068913 to Bar-Zeev et al., entitled “Opacity Filter For See-Through Mounted Display,” filed on Sep. 21, 2010. However, in general, an embodiment of the opacity filter 114 can be a see-through LCD panel, an electrochromic film, or similar device which is capable of serving as an opacity filter. Opacity filter 114 can include a dense grid of pixels, where the light transmissivity of each pixel is individually controllable between minimum and maximum transmissivities. While a transmissivity range of 0-100% is ideal, more limited ranges are also acceptable, such as for example about 50% to 90% per pixel.

A mask of alpha values can be used from a rendering pipeline, after z-buffering with proxies for real-world objects. When the system renders a scene for the augmented reality display, it takes note of which real-world objects are in front of which virtual objects as explained below. If a virtual object is in front of a real-world object, then the opacity may be on for the coverage area of the virtual object. If the virtual object is (virtually) behind a real-world object, then the opacity may be off, as well as any color for that pixel, so the user will see just the real-world object for that corresponding area (a pixel or more in size) of real light. Coverage would be on a pixel-by-pixel basis, so the system could handle the case of part of a virtual object being in front of a real-world object, part of the virtual object being behind the real-world object, and part of the virtual object being coincident with the real-world object. Displays capable of going from 0% to 100% opacity at low cost, power, and weight are the most desirable for this use. Moreover, the opacity filter can be rendered in color, such as with a color LCD or with other displays such as organic LEDs.

Head mounted display device 2 also includes a system for tracking the position of the user's eyes. As will be explained below, the system will track the user's position and orientation so that the system can determine the FOV of the user. However, a human will not perceive everything in front of them. Instead, a user's eyes will be directed at a subset of the environment. Therefore, in one embodiment, the system will include technology for tracking the position of the user's eyes in order to refine the measurement of the FOV of the user. For example, head mounted display device 2 includes eye tracking assembly 134 (FIG. 3), which has an eye tracking illumination device 134A and eye tracking camera 134B (FIG. 4). In one embodiment, eye tracking illumination device 134A includes one or more infrared (IR) emitters, which emit IR light toward the eye. Eye tracking camera 134B includes one or more cameras that sense the reflected IR light. The position of the pupil can be identified by known imaging techniques which detect the reflection of the cornea. For example, see U.S. Pat. No. 7,401,920, entitled “Head Mounted Eye Tracking and Display System”, issued Jul. 22, 2008. Such a technique can locate a position of the center of the eye relative to the tracking camera. Generally, eye tracking involves obtaining an image of the eye and using computer vision techniques to determine the location of the pupil within the eye socket. In one embodiment, it is sufficient to track the location of one eye since the eyes usually move in unison. However, it is possible to track each eye separately.

In one embodiment, the system will use four IR LEDs and four IR photo detectors in rectangular arrangement so that there is one IR LED and IR photo detector at each corner of the lens of head mounted display device 2. Light from the LEDs reflect off the eyes. The amount of infrared light detected at each of the four IR photo detectors determines the pupil direction. That is, the amount of white versus black in the eye will determine the amount of light reflected off the eye for that particular photo detector. Thus, the photo detector will have a measure of the amount of white or black in the eye. From the four samples, the system can determine the direction of the eye.

Another alternative is to use four infrared LEDs as discussed above, but just one infrared CCD on the side of the lens of head mounted display device 2. The CCD may use a small mirror and/or lens (fish eye) such that the CCD can image up to 75% of the visible eye from the glasses frame. The CCD will then sense an image and use computer vision to find the image, much like as discussed above. Thus, although FIG. 3 shows one assembly with one IR transmitter, the structure of FIG. 3 can be adjusted to have four IR transmitters and/or four IR sensors. More or less than four IR transmitters and/or four IR sensors can also be used.

Another embodiment for tracking the direction of the eyes is based on charge tracking. This concept is based on the observation that a retina carries a measurable positive charge and the cornea has a negative charge. Sensors are mounted by the user's ears (near earphones 130) to detect the electrical potential while the eyes move around and effectively read out what the eyes are doing in real time. Other embodiments for tracking eyes can also be used.

FIG. 3 only shows half of the head mounted display device 2. A full head mounted display device may include another set of see-through lenses, another opacity filter, another light-guide optical element, another microdisplay 120, another lens 122, room-facing camera, eye tracking assembly 134, earphones, and temperature sensor.

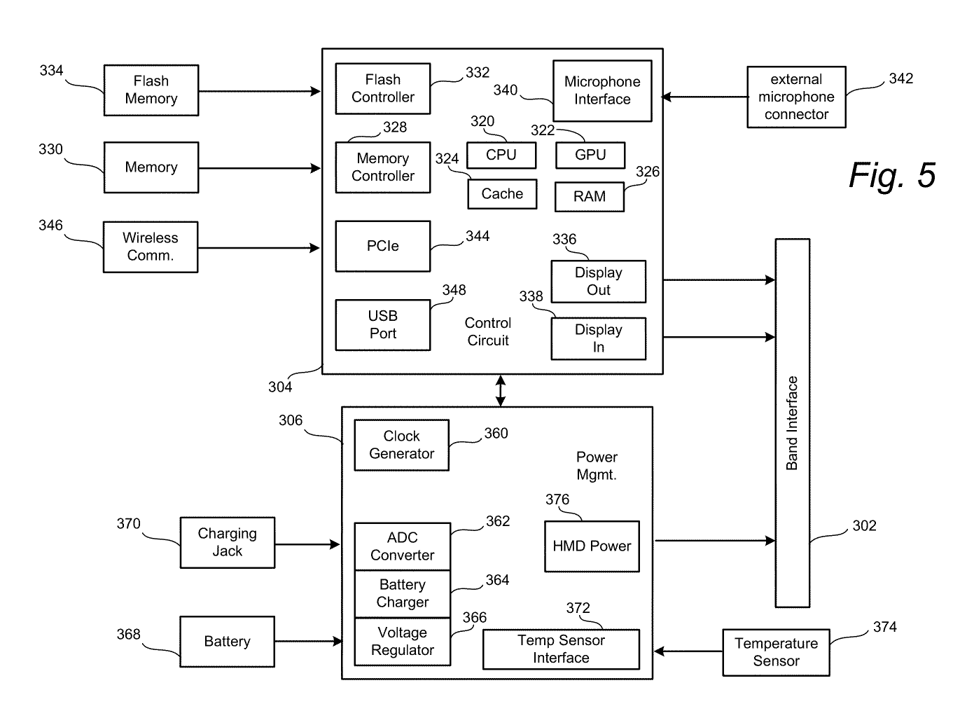

FIG. 4 is a block diagram depicting the various components of head mounted display device 2. FIG. 5 is a block diagram describing the various components of processing unit 4. Head mounted display device 2, the components of which are depicted in FIG. 4, is used to provide a virtual experience to the user by fusing one or more virtual images seamlessly with the user's view of the real world. Additionally, the head mounted display device components of FIG. 4 include many sensors that track various conditions. Head mounted display device 2 will receive instructions about the virtual image from processing unit 4 and will provide the sensor information back to processing unit 4. Processing unit 4 may determine where and when to provide a virtual image to the user and send instructions accordingly to the head mounted display device of FIG. 4.

Some of the components of FIG. 4 (e.g., room-facing camera 112, eye tracking camera 134B, microdisplay 120, opacity filter 114, eye tracking illumination 134A, earphones 130, and temperature sensor 138) are shown in shadow to indicate that there are two of each of those devices, one for the left side and one for the right side of head mounted display device 2. FIG. 4 shows the control circuit 200 in communication with the power management circuit 202. Control circuit 200 includes processor 210, memory controller 212 in communication with memory 214 (e.g., D-RAM), camera interface 216, camera buffer 218, display driver 220, display formatter 222, timing generator 226, display out interface 228, and display in interface 230.

In one embodiment, the components of control circuit 200 are in communication with each other via dedicated lines or one or more buses. In another embodiment, the components of control circuit 200 is in communication with processor 210. Camera interface 216 provides an interface to the two room-facing cameras 112 and stores images received from the room-facing cameras in camera buffer 218. Display driver 220 will drive microdisplay 120. Display formatter 222 provides information, about the virtual image being displayed on microdisplay 120, to opacity control circuit 224, which controls opacity filter 114. Timing generator 226 is used to provide timing data for the system. Display out interface 228 is a buffer for providing images from room-facing cameras 112 to the processing unit 4. Display in interface 230 is a buffer for receiving images such as a virtual image to be displayed on microdisplay 120. Display out interface 228 and display in interface 230 communicate with band interface 232 which is an interface to processing unit 4.

Power management circuit 202 includes voltage regulator 234, eye tracking illumination driver 236, audio DAC and amplifier 238, microphone preamplifier and audio ADC 240, temperature sensor interface 242 and clock generator 244. Voltage regulator 234 receives power from processing unit 4 via band interface 232 and provides that power to the other components of head mounted display device 2. Eye tracking illumination driver 236 provides the IR light source for eye tracking illumination 134A, as described above. Audio DAC and amplifier 238 output audio information to the earphones 130. Microphone preamplifier and audio ADC 240 provides an interface for microphone 110. Temperature sensor interface 242 is an interface for temperature sensor 138. Power management circuit 202 also provides power and receives data back from three axis magnetometer 132A, three axis gyro 132B and three axis accelerometer 132C.

FIG. 5 is a block diagram describing the various components of processing unit 4. FIG. 5 shows control circuit 304 in communication with power management circuit 306. Control circuit 304 includes a central processing unit (CPU) 320, graphics processing unit (GPU) 322, cache 324, RAM 326, memory controller 328 in communication with memory 330 (e.g., D-RAM), flash memory controller 332 in communication with flash memory 334 (or other type of non-volatile storage), display out buffer 336 in communication with head mounted display device 2 via band interface 302 and band interface 232, display in buffer 338 in communication with head mounted display device 2 via band interface 302 and band interface 232, microphone interface 340 in communication with an external microphone connector 342 for connecting to a microphone, PCI express interface for connecting to a wireless communication device 346, and USB port(s) 348. In one embodiment, wireless communication device 346 can include a Wi-Fi enabled communication device, BlueTooth communication device, infrared communication device, etc. The USB port can be used to dock the processing unit 4 to processing unit computing system 22 in order to load data or software onto processing unit 4, as well as charge processing unit 4. In one embodiment, CPU 320 and GPU 322 are the main workhorses for determining where, when and how to insert virtual three-dimensional objects into the view of the user. More details are provided below.

Power management circuit 306 includes clock generator 360, analog to digital converter 362, battery charger 364, voltage regulator 366, head mounted display power source 376, and temperature sensor interface 372 in communication with temperature sensor 374 (possibly located on the wrist band of processing unit 4). Analog to digital converter 362 is used to monitor the battery voltage, the temperature sensor and control the battery charging function. Voltage regulator 366 is in communication with battery 368 for supplying power to the system. Battery charger 364 is used to charge battery 368 (via voltage regulator 366) upon receiving power from charging jack 370. HMD power source 376 provides power to the head mounted display device 2.

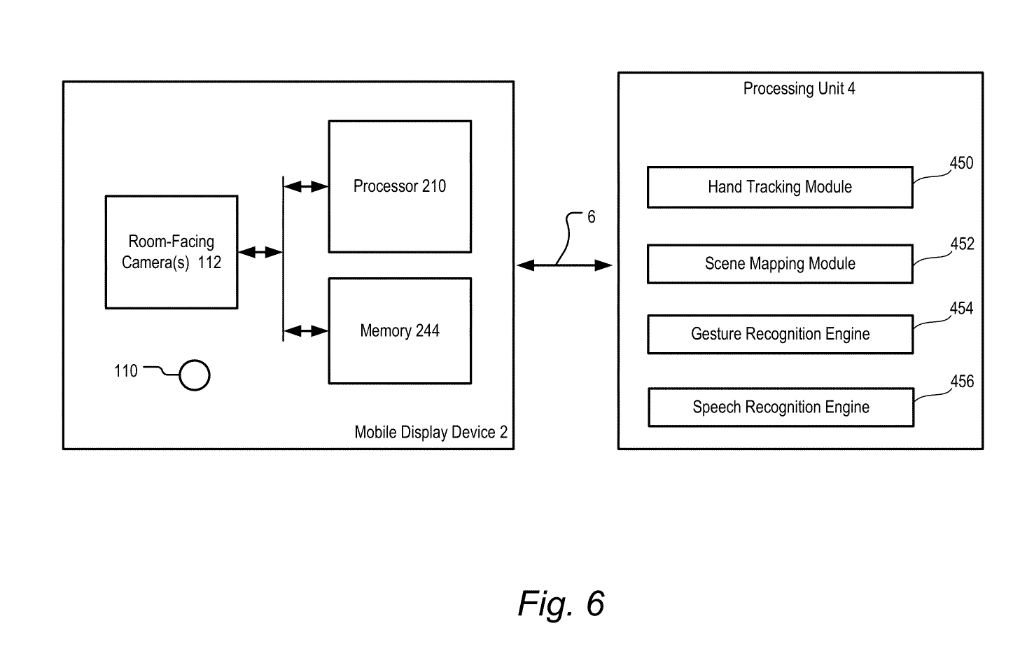

FIG. 6 illustrates a high-level block diagram of the mobile mixed reality assembly 30 including the room-facing camera 112 of the display device 2 and some of the software modules on the processing unit 4. Some or all of these software modules may alternatively be implemented on a processor 210 of the head mounted display device 2. As shown, the room-facing camera 112 provides image data to the processor 210 in the head mounted display device 2. In one embodiment, the room-facing camera 112 may include a depth camera, an RGB camera and an IR light component to capture image data of a scene. As explained below, the room-facing camera 112 may include less than all of these components.

Using for example time-of-flight analysis, the IR light component may emit an infrared light onto the scene and may then use sensors (not shown) to detect the backscattered light from the surface of one or more objects in the scene using, for example, the depth camera and/or the RGB camera. In some embodiments, pulsed infrared light may be used such that the time between an outgoing light pulse and a corresponding incoming light pulse may be measured and used to determine a physical distance from the room-facing camera 112 to a particular location on the objects in the scene, including for example a user's hands. Additionally, in other example embodiments, the phase of the outgoing light wave may be compared to the phase of the incoming light wave to determine a phase shift. The phase shift may then be used to determine a physical distance from the capture device to a particular location on the targets or objects.

According to another example embodiment, time-of-flight analysis may be used to indirectly determine a physical distance from the room-facing camera 112 to a particular location on the objects by analyzing the intensity of the reflected beam of light over time via various techniques including, for example, shuttered light pulse imaging.

In another example embodiment, the room-facing camera 112 may use a structured light to capture depth information. In such an analysis, patterned light (i.e., light displayed as a known pattern such as a grid pattern, a stripe pattern, or different pattern) may be projected onto the scene via, for example, the IR light component. Upon striking the surface of one or more targets or objects in the scene, the pattern may become deformed in response. Such a deformation of the pattern may be captured by, for example, the 3-D camera and/or the RGB camera (and/or other sensor) and may then be analyzed to determine a physical distance from the room-facing camera 112 to a particular location on the objects. In some implementations, the IR light component is displaced from the depth and/or RGB cameras so triangulation can be used to determined distance from depth and/or RGB cameras. In some implementations, the room-facing camera 112 may include a dedicated IR sensor to sense the IR light, or a sensor with an IR filter.

It is understood that the present technology may sense objects and three-dimensional positions of the objects without each of a depth camera, RGB camera and IR light component. In embodiments, the room-facing camera 112 may for example work with just a standard image camera (RGB or black and white). Such embodiments may operate by a variety of image tracking techniques used individually or in combination. For example, a single, standard image room-facing camera 112 may use feature identification and tracking. That is, using the image data from the standard camera, it is possible to extract interesting regions, or features, of the scene. By looking for those same features over a period of time, information for the objects may be determined in three-dimensional space.

In embodiments, the head mounted display device 2 may include two spaced apart standard image room-facing cameras 112. In this instance, depth to objects in the scene may be determined by the stereo effect of the two cameras. Each camera can image some overlapping set of features, and depth can be computed from the parallax difference in their views.

A further method for determining a scene map with positional information within an unknown environment is known as simultaneous localization and mapping (SLAM). One example of SLAM is disclosed in U.S. Pat. No. 7,774,158, entitled “Systems and Methods for Landmark Generation for Visual Simultaneous Localization and Mapping.” Additionally, data from the IMU can be used to interpret visual tracking data more accurately.

The processing unit 104 includes a scene mapping module 452. Using the data from the front-facing camera(s) 112 as described above, the scene mapping module is able to map objects in the scene (including one or both of the user's hands) to a three-dimensional frame of reference. Further details of the scene mapping module are described below.

In order to track the position of a user's hand(s) in the FOV, the hands are initially recognized from the image data. The processing unit 4 may implement a hand recognition and tracking module 450. The module 450 receives the image data from the room-facing camera 112 and is able to identify a user's hand, and a position of the user's hand, in the FOV. An example of the hand recognition and tracking module 450 is disclosed in U.S. Patent Publication No. 2012/0308140, entitled, “System for Recognizing an Open or Closed Hand.” However, in general the module 450 may examine the image data to discern width and length of objects which may be fingers, spaces between fingers and valleys where fingers come together so as to identify and track a user's hands in their various positions.

The processing unit 4 may further include a gesture recognition engine 454 for receiving skeletal model data for one or more users in the scene and determining whether the user is performing a predefined gesture or application-control movement affecting an application running on the processing unit 4. More information about gesture recognition engine 454 can be found in U.S. patent application Ser. No. 12/422,661, entitled “Gesture Recognizer System Architecture,” filed on Apr. 13, 2009.

As mentioned above, a user may perform various verbal gestures, for example in the form of spoken commands to select objects and possibly indicate the digital action sought. Accordingly, the present system further includes a speech recognition engine 456. The speech recognition engine 456 may operate according to any of various known technologies.

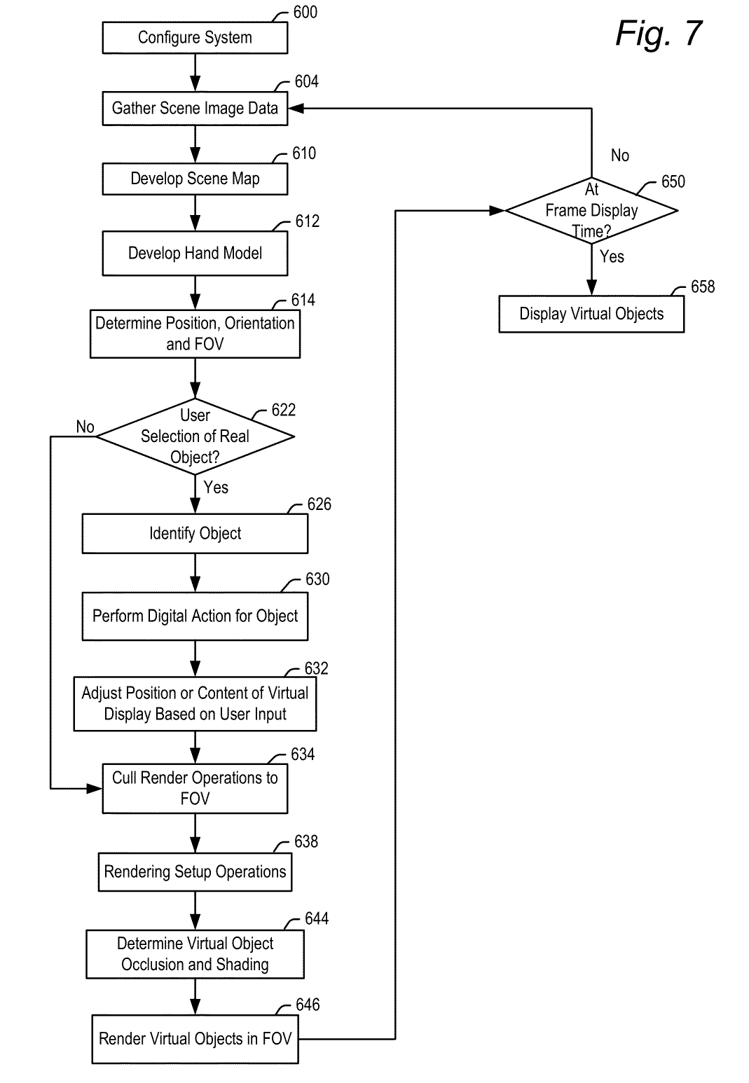

In one example embodiment, the head mounted display device 2 and processing unit 4 work together to create the scene map or model of the environment that the user is in and tracks various moving or stationary objects in that environment. In addition, the processing unit 4 tracks the FOV of the head mounted display device 2 worn by the user 18 by tracking the position and orientation of the head mounted display device 2. Sensor information, for example from the room-facing cameras 112 and IMU 132, obtained by head mounted display device 2 is transmitted to processing unit 4. The processing unit 4 processes the data and updates the scene model. The processing unit 4 further provides instructions to head mounted display device 2 on where, when and how to insert any virtual three-dimensional objects. In accordance with the present technology, the processing unit 4 further detects contact or interaction with an object in the FOV. Upon such interaction, the processing unit identifies the object and performs a digital action with respect to the identified object, such as for example providing a virtual display of additional information relating to the object. Each of the above-described operations will now be described in greater detail with reference to the flowchart of FIG. 7.

FIG. 7 is high level flowchart of the operation and interactivity of the processing unit 4 and head mounted display device 2 during a discrete time period such as the time it takes to generate, render and display a single frame of image data to each user. In embodiments, data may be refreshed at a rate of 60 Hz, though it may be refreshed more often or less often in further embodiments.

In general, the system may generate a scene map having x, y, z coordinates of the environment and objects in the environment such as virtual objects and real world objects including a user's hand(s). For a given frame of image data, a user's view may include one or more real and/or virtual objects. As a user turns his head, for example left to right or up and down, positions of stationary real world and virtual objects do not change, but their positions do change in the user's FOV. Such objects may be referred to herein as world locked. Some virtual objects explained below may remain in the same position in a user's FOV, even where a user moves his or her head. Such virtual objects may be referred to herein as being head locked.

The system for presenting a virtual environment to one or more users 18 may be configured in step 600. For example, a user 18 or operator of the system may specify the format of how virtual objects are to be presented, whether they are to be world locked or head locked virtual objects, and how, when and where they are to be presented. In an alternative embodiment, an application running on processing unit 4 can configure default formatting and settings for virtual objects that are to be presented. The user may also have the option to select and move virtual objects after they are displayed. This may be carried out for example by the user performing grabbing and moving gestures with his hands, though it may be carried out in other ways in further embodiments.

In steps 604 the processing unit 4 gathers data from the scene. This may be image data sensed by the head mounted display device 2, and in particular, by the room-facing cameras 112, the eye tracking assemblies 134 and the IMU 132.

A scene map may be developed in step 610 identifying the geometry of the scene as well as the geometry and positions of objects within the scene. In embodiments, the scene map generated in a given frame may include the x, y and z positions of a user's hand(s), other real world objects and virtual objects in the scene. Methods for gathering depth and position data have been explained above.

The processing unit 4 may next translate the image data points captured by the sensors into an orthogonal 3-D scene map. This orthogonal 3-D scene map may be a point cloud map of all image data captured by the head mounted display device cameras in an orthogonal x, y, z Cartesian coordinate system. Methods using matrix transformation equations for translating camera view to an orthogonal 3-D world view are known. See, for example, David H. Eberly, “3d Game Engine Design: A Practical Approach To Real-Time Computer Graphics,” Morgan Kaufman Publishers (2000).

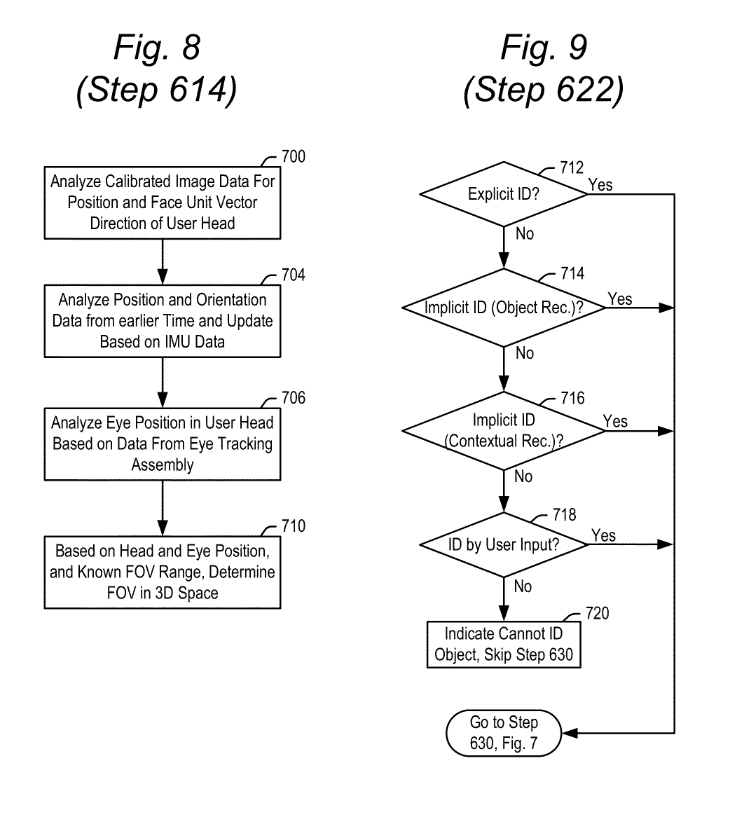

In step 612, the system may detect and track a user's hands as described above, and update the scene map based on the positions of moving hands and other moving objects. In step 614, the processing unit 4 determines the x, y and z position, the orientation and the FOV of the head mounted display device 2 within the scene. Further details of step 614 are now described with respect to the flowchart of FIG. 8.

In step 700, the image data for the scene is analyzed by the processing unit 4 to determine both the user head position and a face unit vector looking straight out from a user's face. The head position may be identified from feedback from the head mounted display device 2, and from this, the face unit vector may be constructed. The face unit vector may be used to define the user's head orientation and, in examples, may be considered the center of the FOV for the user. The face unit vector may also or alternatively be identified from the camera image data returned from the room-facing cameras 112 on head mounted display device 2. In particular, based on what the cameras 112 on head mounted display device 2 see, the processing unit 4 is able to determine the face unit vector representing a user's head orientation.

In step 704, the position and orientation of a user's head may also or alternatively be determined from analysis of the position and orientation of the user's head from an earlier time (either earlier in the frame or from a prior frame), and then using the inertial information from the IMU 132 to update the position and orientation of a user's head. Information from the IMU 132 may provide accurate kinematic data for a user's head, but the IMU typically does not provide absolute position information regarding a user's head. This absolute position information, also referred to as “ground truth,” may be provided from the image data obtained from the cameras on the head mounted display device 2.

In embodiments, the position and orientation of a user's head may be determined by steps 700 and 704 acting in tandem. In further embodiments, one or the other of steps 700 and 704 may be used to determine head position and orientation of a user's head.

It may happen that a user is not looking straight ahead. Therefore, in addition to identifying user head position and orientation, the processing unit may further consider the position of the user's eyes in his head. This information may be provided by the eye tracking assembly 134 described above. The eye tracking assembly is able to identify a position of the user's eyes, which can be represented as an eye unit vector showing the left, right, up and/or down deviation from a position where the user's eyes are centered and looking straight ahead (i.e., the face unit vector). A face unit vector may be adjusted to the eye unit vector to define where the user is looking.

In step 710, the FOV of the user may next be determined. The range of view of a user of a head mounted display device 2 may be predefined based on the up, down, left and right peripheral vision of a hypothetical user. In order to ensure that the FOV calculated for a given user includes objects that a particular user may be able to see at the extents of the FOV, this hypothetical user may be taken as one having a maximum possible peripheral vision. Some predetermined extra FOV may be added to this to ensure that enough data is captured for a given user in embodiments.

The FOV for the user at a given instant may then be calculated by taking the range of view and centering it around the face unit vector, adjusted by any deviation of the eye unit vector. In addition to defining what a user is looking at in a given instant, this determination of a user's FOV is also useful for determining what may not be visible to the user. As explained below, limiting processing of virtual objects to those areas that are within a particular user's FOV may improve processing speed and reduces latency.

As noted, aspects of the present technology relate to detecting contact or other interaction with a real world object, identifying that object and then performing some digital action with respect to that object. In step 622, the processing unit looks for selection of a physical object within the field of view. Objects may be selected for example by contact, pointing, gazing, voice commands or other interactions as described above with respect to FIGS. 1A-1D.

If selection of an object is detected, the processing unit 4 next identifies the object in step 626. Further details of step 626 will now be explained with reference to the flowchart of FIG. 9. In step 712, the processing unit 4 attempts to identify an explicit marking on the object. In particular, the object may include some explicit identifier that may be read by the room-facing cameras 112. Examples of explicit IDs or markings which may be read on the object include bar and QR codes. Explicit IDs or markings may also include a name written on the object or an alphanumeric identifier such as a product code. The room-facing cameras 112 may capture an image of the alphanumeric name or identifier, which then may be recognized as alphanumeric characters by optical character recognition software running on the processing unit 4.

The processing unit 4 at least assists in the identification of the selected object 14. That is, in some embodiments, the processing unit 4 is able to identify the selected object using its own resources. In further embodiments, the processing unit 4 working in tandem with external resources is able to identify the selected object. These external resources may be an external cloud service, website or database.

For example, the processing unit 4 may have as a resource a database stored in memory 330 linking the identity of the object with the captured bar code, QR code, or its recognized alphanumeric name or identifier. As noted above, the processing unit 4 may communicate with a remote website or service including one or more servers or computing devices. The processing unit may alternatively or additionally contact a remote website in order to identify an object from the captured bar code, QR code, or its recognized alphanumeric name or identifier. In a further embodiment, the remote service may be or include a clearinghouse for the purpose of storing object identities in a look-up table with their associated bar code, QR code, or recognized alphanumeric name or identifier. As explained below, this clearinghouse may store additional identification features associated with a given object.

If no explicit identifier is detected, the processing unit 4 may further look for an implicit identifier or aspect of the object in step 714. The implicit aspects of the object may be object or surface characteristics which can be detected by the room-facing cameras 112. As noted above, the room-facing cameras may include any of a variety of different types of cameras and emitters, including for example a black/white standard image camera, an RGB standard image camera, a depth camera and an IR emitter. Technologies associated with these different image capture devices may be used to discern features of an object such as its shape, edges, corners, surface texture, color, reflectivity or some unique or distinctive features of an object. These features may allow the processing unit 4 to identify the object, either working by itself or in tandem with a remote website or database such as the above-described clearinghouse.

The processing unit 4 may additionally or alternatively identify implicit aspects of an object by various known algorithms for identifying cues such as points, lines or surfaces of interest from an object. Such algorithms are set forth for example in Mikolajczyk, K., and Schmid, C., “A Performance Evaluation of Local Descriptors,” IEEE Transactions on Pattern Analysis & Machine Intelligence, 27, 10, 1615-1630 (2005). A further method of detecting cues with image data of an object is the Scale-Invariant Feature Transform (SIFT) algorithm. The SIFT algorithm is described for example in U.S. Pat. No. 6,711,293, entitled, “Method and Apparatus for Identifying Scale Invariant Features in an Image and Use of Same for Locating an Object in an Image.” Another cue detector method is the Maximally Stable Extremal Regions (MSER) algorithm. The MSER algorithm is described for example in the paper by J. Matas, O. Chum, M. Urba, and T. Pajdla, “Robust Wide Baseline Stereo From Maximally Stable Extremal Regions,” Proc. of British Machine Vision Conference, pages 384-396 (2002).

If an object is not identified by object/surface recognition, the processing unit 4 may check in step 716 whether there are any implicit identifiers of the object based on contextual recognition. Contextual recognition of an object refers to the use of contextual data discerned by the head mounted display device 2 or processing unit 4 that identifies or aids in the identification of an object.

Contextual data may relate to identifying a location of the user and object. Using various known location-based algorithms, the processing unit 4 may be able to locate where the user is, including for example that the user is in a specific store. If the processing unit can identify a specific location or store, the processing unit may be able to narrow the corpus of possible identities of an object. For example, if the processing unit can identify that the user is either at home or work or friend's house, or in a in a toy store, clothing store, supermarket, etc., this can narrow the world of possible objects which the user may select, or at least provide useful information as to the type of object that would likely be selected.

Contextual data may further relate to an activity in which the user is engaged. Again, recognition of what the user is doing can narrow the world of possible objects which the user may select, or at least provide useful information as to the type of object that would likely be selected.

Contextual data may further relate to detected audio and voice data. In embodiments, the microphone in the head mounted display device 2 may detect voice or other sounds, and the processing unit 4 may run voice or audio recognition algorithms to identify the voice as belonging to a specific person or identify the sound as coming from a specific object. Recognition of a voice or sound may narrow the world of possible objects which the user may select, or at least provide useful information as to the type of object that would likely be selected.

In embodiments, if the processing unit is unable to identify contextual data, the processing unit may prompt the user to provide an identity of the object in step 718. The processing unit 4 may cause a virtual object to be displayed including text asking the user to provide an identity or additional information regarding the identity of an object. The present system may accept this user input in predefined formats or as free form speech.

If the processing unit 4 is able to identify an object from any of the above-described criteria, the present invention may perform some digital action with respect to the identified object in step 630 explained below. On the other hand, if an object is not identified by the processing unit 4, the processing unit 4 may generate a virtual display shown to the user 18 indicating that it was unable to identify the object in step 720. In this event, step 630 of performing the digital action is skipped. It is understood that steps other than or in addition to steps 712, 714, 716 and 718 may be used to identify an object.

Moreover, it is understood that, instead of the linear progression of steps 712, 714, 716, 718 set forth in FIG. 9, some or all of those steps may be performed in combination with each other, with an identification of an object being generated based on the output of each of the steps considered together. In embodiments, the steps may be weighted differently. For example, where an object is identified by the explicit data, this may be weighted higher than identification of an object by implicit data such as its detected shape.

As indicated above, a clearinghouse may be provided including the identity of various objects. This clearinghouse may be set up and managed by a hosted cloud service. Additionally or alternatively, the clearinghouse may be populated and grow by crowdsourcing. When a previously unknown object is identified, for example via user input, the identity of the object may be uploaded to the clearinghouse database, together with descriptive data, such as its shape or other identifying features. In a further example, it is conceivable that a friend of the user viewed and identified an object, and left a message for the user as to the identity of the object. This message may be stored in a database associated with the processing device 4, and the user may access this message upon viewing the object.

Referring again to FIG. 7, if an object is identified in step 626, the processing unit may perform any of various digital actions with respect to the object. In embodiments, the processing unit 4 may prompt a user upon identification of an object as to the type of digital action the user would like performed. In further embodiments, the digital action may be predefined and automatic upon selection and identification of an object.

In embodiments, the digital action may be the presentation of a virtual display slate 12 (FIGS. 1A-1D) including a display of text and/or graphics providing information regarding the object. A virtual display slate 12 is a virtual screen displayed to the user on which content may be presented to the user. The opacity filter 114 can be used to mask real world objects and light behind (from the user's view point) the virtual display slate 12, so that the virtual display slate 12 appears as a virtual screen for viewing content.

A virtual display slate 12 may be displayed to a user in a variety of forms, but in embodiments, the slate may have a front where content is displayed, top, bottom and side edges where a user would see the thickness of the virtual display if the user's viewing angle was aligned with (parallel to) a plane in which the display is positioned, and a back which is blank. In embodiments, the back may display a mirror image of what is displayed on the front. This is analogous to displaying a movie on a movie screen. Viewers can see the image on the front of the screen, and the mirror image on the back of the screen. As explained below, the information relating to an object may be displayed to the user as three-dimensional object instead of as text and/or graphics on a virtual display slate.

The type of information which may be displayed to the user may vary greatly, possibly depending on the type of object which is selected and identified. In one example, objects may be consumer products within a store. In such examples, the information displayed may be a price of the object, a view of the object outside of its can, box or packaging, consumer reviews on the object, friends' reviews of the objects, specifications for the object, recommendations for similar or complimentary products, or a wide variety of other textual or graphical information. The information displayed on the virtual display slate 12 may come from one or more websites identified by the processing unit upon identifying the object. Alternatively or additionally, the information may come from the above-described cloud service and clearinghouse database.

Instead of displaying information, the virtual display slate may perform a variety of other digital actions. In one example, the virtual display may provide an interface with which a user may interact, for example to purchase the object via a credit card transaction. As another example, the virtual display may provide access to a digital service, for example enabling a user to make a booking for tickets, or reservations for example for a meal, flight or hotel. The virtual display slate may for example provide an email/messaging interface so that the user can email/text friends regarding the object. The user interface may have other functionality to provide additional features and digital actions regarding the selected object. In embodiments, the information displayed on a virtual display slate may be a selectable hyperlink so that a user may select the hyperlinked information to receive additional information on the selected topic. In further embodiments, more than one virtual display slate may be displayed, each including information on the selected object. Further examples of objects and displayed virtual information are described below.

As noted above, a user may interact with the virtual display. Upon such interaction, any new information may be displayed to the user on the virtual display in step 632. The virtual display may be head locked or world locked. In either example, instead of or in addition to changing the information displayed, a user may move the virtual display to a different location in the user's FOV, or resize the virtual display. Predefined gestures such as grabbing, pulling and pushing may move the virtual display to a desired location. Predefined gestures such as pulling/pushing corners of the display away from or toward each other may resize the virtual display to a desired size.

In step 634, the processing unit 4 may cull the rendering operations so that just those virtual objects which could possibly appear within the final FOV of the head mounted display device 2 are rendered. The positions of other virtual objects may still be tracked, but they are not rendered. It is also conceivable that, in further embodiments, step 634 may be skipped altogether and the entire image is rendered.

The processing unit 4 may next perform a rendering setup step 638 where setup rendering operations are performed using the scene map and FOV received in steps 610 and 614. Once virtual object data is received, the processing unit may perform rendering setup operations in step 638 for the virtual objects which are to be rendered in the FOV. The setup rendering operations in step 638 may include common rendering tasks associated with the virtual object(s) to be displayed in the final FOV. These rendering tasks may include for example, shadow map generation, lighting, and animation. In embodiments, the rendering setup step 638 may further include a compilation of likely draw information such as vertex buffers, textures and states for virtual objects to be displayed in the predicted final FOV.

Using the information regarding the locations of objects in the 3-D scene map, the processing unit 4 may next determine occlusions and shading in the user's FOV in step 644. In particular, the scene map has x, y and z positions of objects in the scene, including any moving and non-moving virtual or real objects. Knowing the location of a user and their line of sight to objects in the FOV, the processing unit 4 may then determine whether a virtual object (such as a virtual display screen 12) partially or fully occludes the user's view of a real world object. Additionally, the processing unit 4 may determine whether a real world object partially or fully occludes the user's view of a virtual object (such as a virtual display screen 12).

In step 646, the GPU 322 of processing unit 4 may next render an image to be displayed to the user. Portions of the rendering operations may have already been performed in the rendering setup step 638 and periodically updated. Any occluded virtual objects may not be rendered, or they may be rendered. Where rendered, occluded objects will be omitted from display by the opacity filter 114 as explained above.

In step 650, the processing unit 4 checks whether it is time to send a rendered image to the head mounted display device 2, or whether there is still time for further refinement of the image using more recent position feedback data from the head mounted display device 2. In a system using a 60 Hertz frame refresh rate, a single frame is about 16 ms.

If time to display an updated image, the images for the one or more virtual objects are sent to microdisplay 120 to be displayed at the appropriate pixels, accounting for perspective and occlusions. At this time, the control data for the opacity filter is also transmitted from processing unit 4 to head mounted display device 2 to control opacity filter 114. The head mounted display would then display the image to the user in step 658.

On the other hand, where it is not yet time to send a frame of image data to be displayed in step 650, the processing unit may loop back for more recent sensor data to refine the predictions of the final FOV and the final positions of objects in the FOV. In particular, if there is still time in step 650, the processing unit 4 may return to step 604 to get more recent sensor data from the head mounted display device 2.

The processing steps 600 through 658 are described above by way of example only. It is understood that one or more of these steps may be omitted in further embodiments, the steps may be performed in differing order, or additional steps may be added.

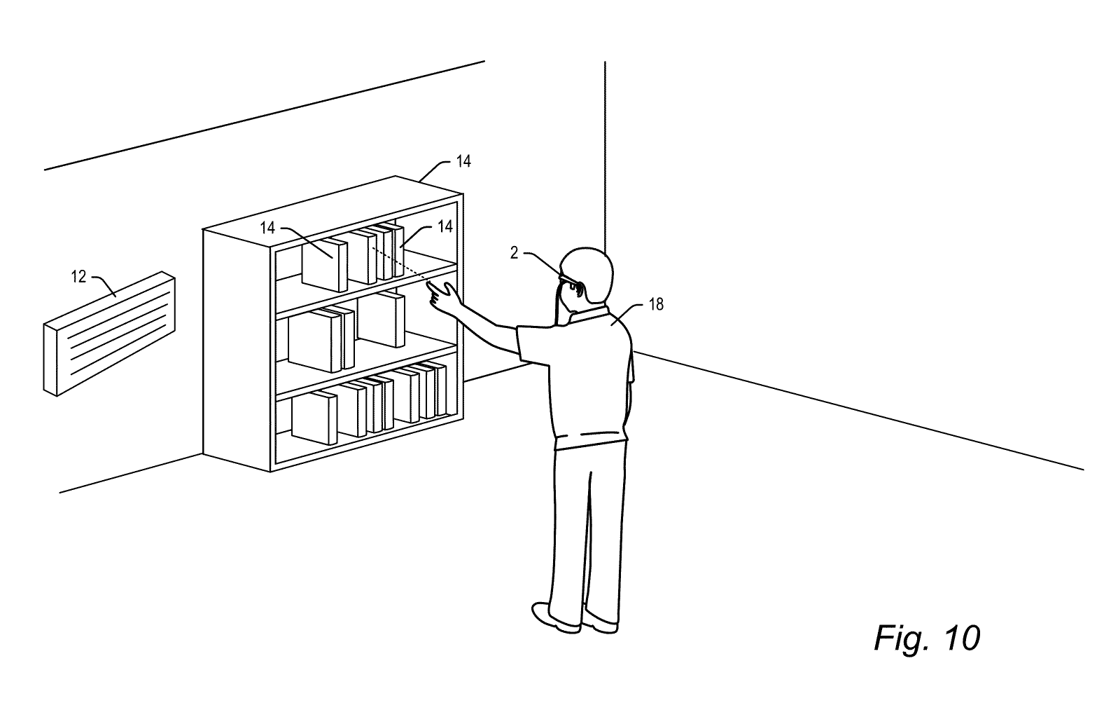

FIGS. 10-14 illustrate further examples of the present technology. FIG. 10 illustrates an example where a user is at home, and has selected a real world object 14, a book in this instance. The present system identified the book and performed a digital action relating to the book. In this example, the digital action was to present a virtual display slate 12 including information on the selected book. In further examples, the digital action may be to present an interactive virtual user interface to the user 18, such as for example on the virtual display slate 12. In such examples, the user could interact with the user interface, for example to send a recommendation regarding the selected book to a friend. As another option, the user could interact with the user interface to post to a social website regarding the selected book or other real world object (such as consumer products). The user could comment on the object, or “like” the object.

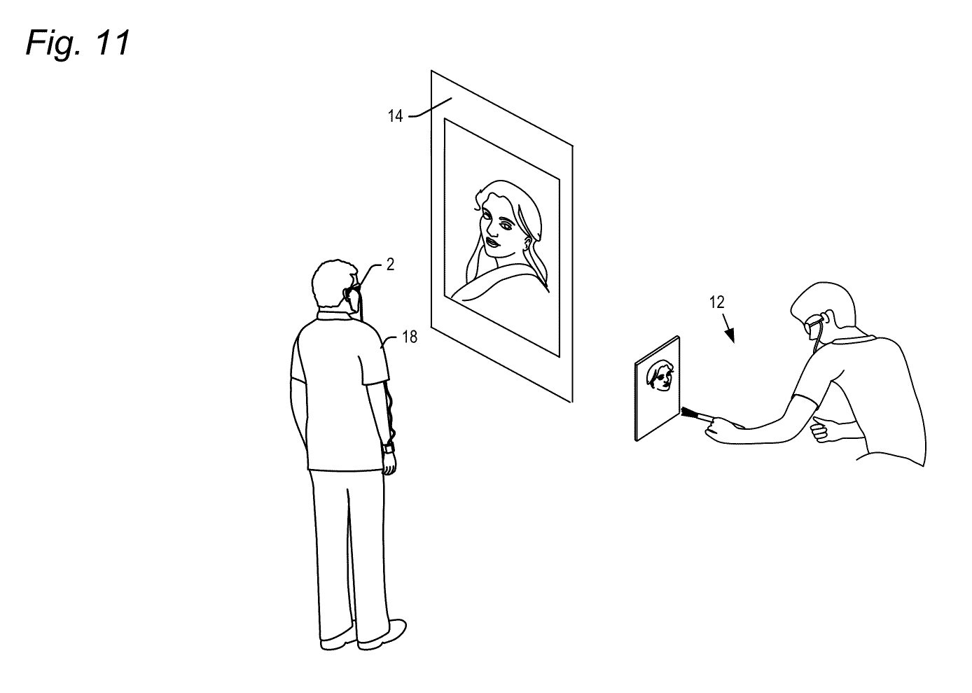

FIG. 11 illustrates an example where the user is viewing a real world object 14, a portrait in this instance. The user has selected the portrait, for example by gazing at it. The present system identified the portrait and performed a digital action relating to the portrait. In this example, the digital action was to present a three-dimensional virtual image 12 of the painter of the portrait showing the painter in the act of painting. The three-dimensional virtual image may be static, or may be dynamic, showing the artist paint the portrait.

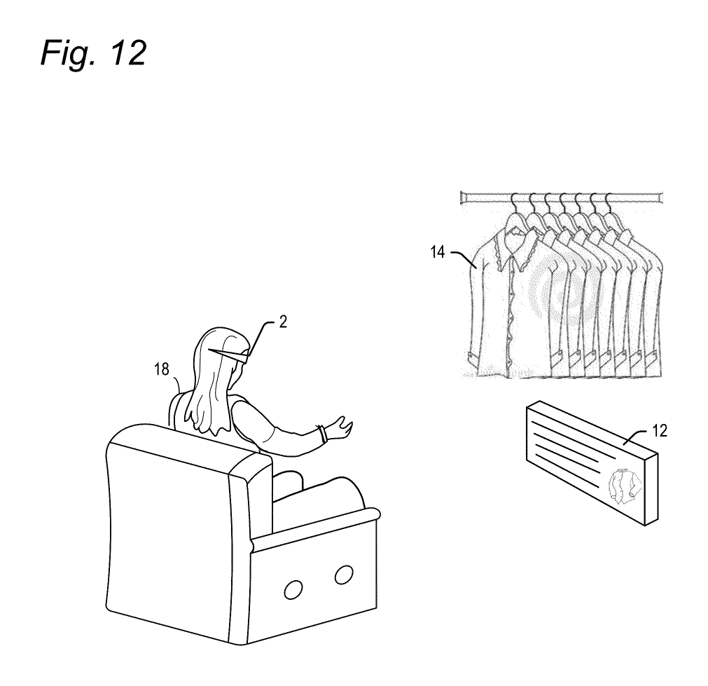

FIG. 12 illustrates an example of a user selecting a real world object 14, an item of clothing this instance. The present system identified the item of clothing and performed a digital action relating to the item of clothing. In this example, the digital action was to present a virtual display slate 12 including information on the selected item of clothing.

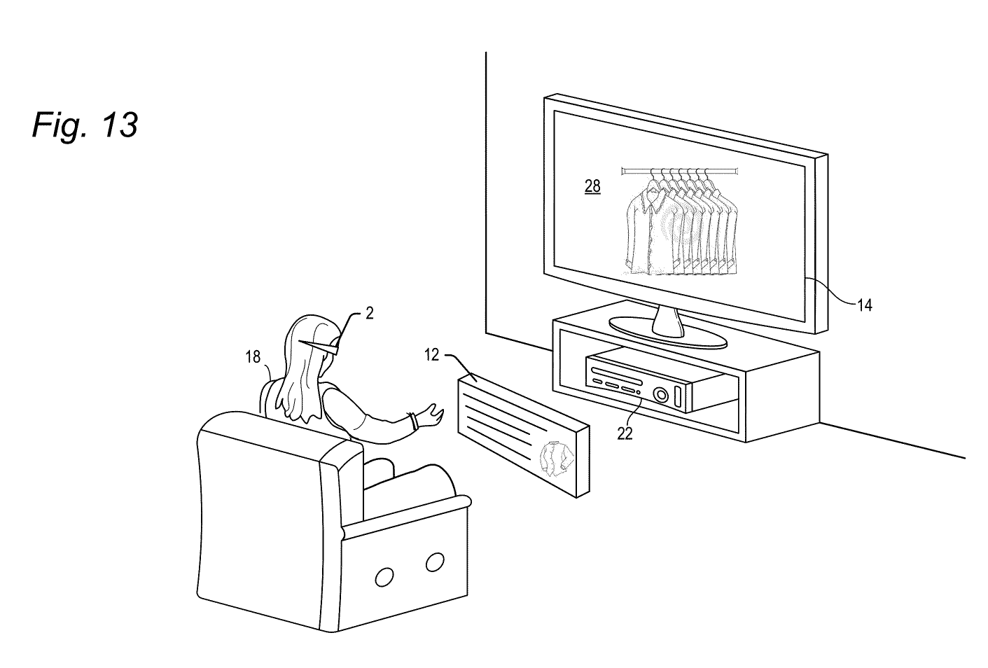

FIG. 13 illustrates a further example of a user selecting a real world object 14. In the examples described above, the real world object 14 is a three-dimensional object in the environment of the user. However, it is conceivable that the real world object 14 be remote from the user's environment and presented to the user as a two-dimensional object 14, e.g., an image on a display 28. In this example, the image may come from a website, via a computing device 22. However, the image may alternatively come from a user's television operating without a computing device 22. In this example, the present system identified the item of clothing on the display and performed a digital action relating to the item of clothing. In this example, the digital action was to present a virtual display slate 12 including information on the selected item of clothing.

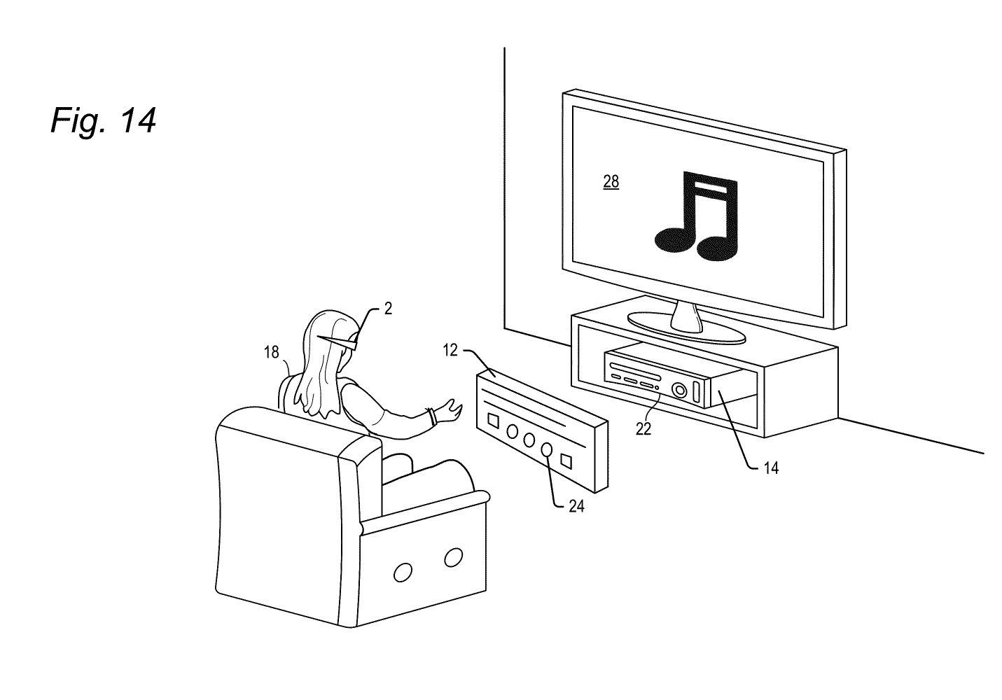

FIG. 14 illustrates a further embodiment where the real world object 14 interacted with is the computing device 22. The computing device 22 in such an embodiment may be any type of computing device such as for example a desktop computer, laptop computer, tablet or smart phone. The processing unit 4 may communicate with the computing device 22 via any of a variety of communication protocols, including via BlueTooth, LAN or other wireless or wired protocol. In this example, the user may select the real world object 14, i.e., the computing device 22, and then perform a digital action in the form of issuing a command to the computing device to affect a change or control action to the operating system of the computing device 22, or an application running on the computing device.

As one of any number of examples, FIG. 14 shows a music application running on the computing device 22. The user 18 may perform a digital action to change the song being played, change the volume, find out more about the artist, end the application, open a new application, etc. Other digital actions include pairing with the computing device 22, or accessing and interacting with a third party website via the computing device 22, where webpages may be displayed on display 28. Such digital actions may be performed by the processing unit 4 presenting a virtual object 12 having virtual controls 24 which can be interacted with by the user to affect some control action on the computing device 22. Alternatively, the user may speak the desired digital control action (without displaying a virtual object). Upon issuing the command, the command may be communicated from the processing unit 4 to the computing device 22, which then implements the control action.

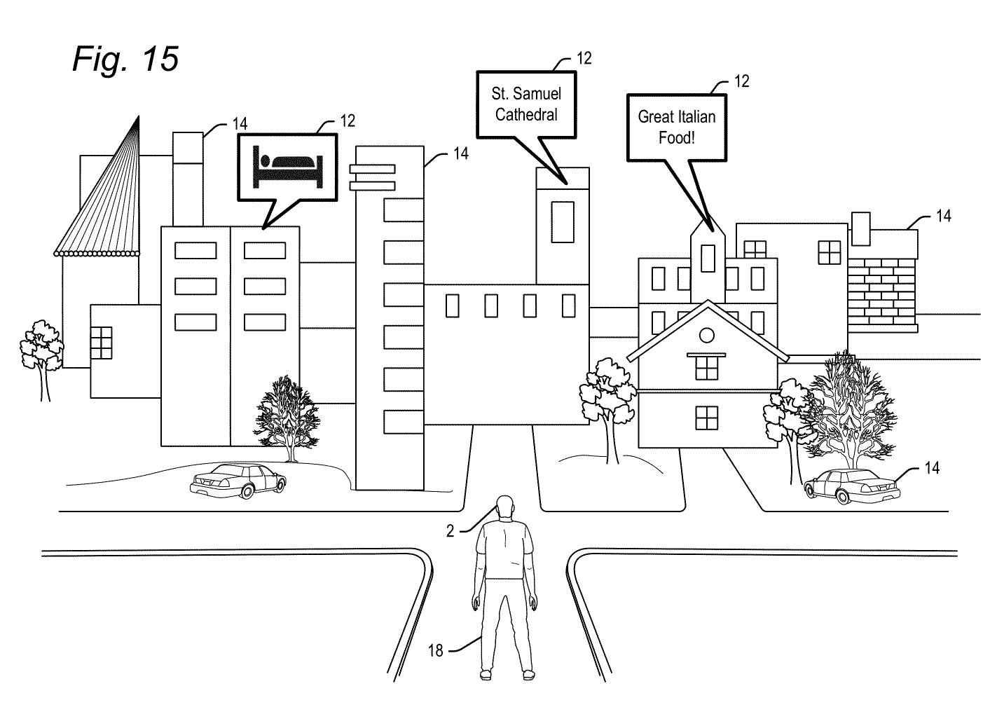

FIG. 15 illustrates a further example where the user is viewing real world objects 14, a cityscape with a number of buildings in this instance. The user may for example be a tourist, arriving a new city or other location and is interested in finding out about interesting places in the city or other location. In this example, the present system identified certain buildings in the cityscape and performed a digital action relating to the buildings. In this example, the digital action was to present a number of virtual display slates 12, each displayed connected to or otherwise associated with its building. Each virtual display slate 12 provides information on its associated building. It is understood that the real world objects to be identified in this example may be other structures, landmarks, parks or bodies of water, which the user may select for example by pointing or gazing.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A system for presenting a virtual environment, the virtual environment being coextensive with a real world space, the system comprising:
a display device including a display unit for displaying one or more virtual objects in the virtual environment; and
a processing unit operatively coupled to the display device, the processing unit at least assisting in identifying a selected object and the processing unit performing a digital action resulting in display of a virtual object by the display device related to the selected object once identified.

2. The system of claim 1, the processing unit assisting in identifying the selected object by identifying an explicit marking on the selected object.

3. The system of claim 2, wherein the explicit marking is at least one of a bar code, a QR code, a written name and a written alphanumeric code.

4. The system of claim 1, the processing unit assisting in identifying the selected object by identifying implicit aspects of the selected object.

5. The system of claim 4, wherein the display device includes a camera, the implicit aspects being object or surface characteristics detected by the camera.

6. The system of claim 1, the processing unit assisting in identifying the selected object by identifying contextual aspects of an environment in which the object is selected.

7. The system of claim 1, further comprising a database in communication with the processing unit, the processing unit identifying the selected object from the database.

8. The system of claim 1, wherein the digital action comprises displaying a virtual display slate via the display device, the virtual display slate displaying at least one of text and graphics providing information on the selected object.

9. The system of claim 1, wherein the digital action comprises displaying a three-dimensional virtual object via the display device, the three-dimensional virtual object providing information on the selected object.

10. The system of claim 1, wherein the object is selected by the processing device detecting a user contacting the object, pointing at the object, gazing at the object or verbally selecting the object.

11. A system for presenting a virtual environment, the virtual environment being coextensive with a real world space, the system comprising:
a display device including a display unit for displaying one or more virtual objects in the virtual environment; and
a processing unit operatively coupled to the display device, the processing unit at least assisting in identifying a selected real world object and the processing unit generating a virtual object displayed by the display device, the virtual object providing information with respect to the identified real world object.

12. The system of claim 11, the processing unit identifying the real world object using data stored on at least one of a database associated with the processing unit, a website and a remote clearinghouse of object information.

13. The system of claim 11, wherein the real world object is a product.

14. The system of claim 11, wherein the display device is a head mounted display device and the virtual object displayed by the display device provides consumer information on the identified product.

15. A method for presenting a virtual environment, the virtual environment being coextensive with a real world space, the method comprising:
(a) receiving selection of a real world object in the real world space;
(b) sensing at least one of markings and aspects of the real world object selected in said step (a);
(c) identifying the real world object from at least one of the markings and aspects of the real world object sensed in said step (b), and user input; and
(d) performing a digital action relating to the real world object upon said step (c) of identifying the real world object, said step of performing a digital action comprising the step of displaying a virtual object via a display device.

16. The method of claim 15, wherein said step (a) of receiving selection of a real world object comprises the step of receiving selection of one of a consumer product, a book, and a computing device.

17. The method of claim 16, wherein said step (d) of performing a digital action relating to the real world object, where the real world object is a consumer product, comprises the step of displaying a virtual object providing at least one of a price of the consumer product, a view of the consumer product, a review of the consumer product, specifications for the consumer product, a recommendation for a similar product, a recommendation for a complimentary product, and presenting a user interface for accessing a digital service;
and wherein said step (d) of performing a digital action relating to the real world object, where the real world object is a book, comprises the step of displaying a virtual object allowing a user to recommend the book to a friend or comment on the book on a social media website;
and wherein said step (d) of performing a digital action relating to the real world object, where the real world object is a computing device, comprises the step of issuing a command to the computing device.

18. The method of claim 16, wherein said step (d) of performing a digital action relating to the real world object comprises the step of displaying a virtual object with which a user may interact to purchase the consumer product.

19. The method of claim 15, wherein said step (b) of sensing at least one of markings and aspects of the real world object comprise the step of sensing at least one of a bar code, a QR code, a written name and an alphanumeric product code.

20. The method of claim 15, wherein said step (b) of sensing at least one of markings and aspects of the real world object comprise the step of sensing at least one of a shape, edges, corners, surface texture, color, reflectivity, a unique feature of the object and distinctive features of the object.
